(19) United States
(12) Patent Application Publication
(10) Pub. No.: US 2016/0063475 A1
(43) Pub. Date: Mar. 3, 2016

(54) Facilitating Transactions Between Buyers And Sellers

(71) Applicant: Lance Yule, (US)

(72) Inventor: Lance Yule, Portland, ME (US)

(73) Assignee: Lance Yule, Portland, ME (US)

(21) Appl. No.: 14/836,459

(22) Filed: Aug. 26, 2015

Related U.S. Application Data
(60) Provisional application No. 62/042,863, filed on Aug. 28, 2014.

(51) Int. Cl. G06Q 20/32; G01C 21/00

(52) U.S. Cl. CPC G06Q 20/325; G06Q 20/3224; G01C 21/00

(57) ABSTRACT

A method includes receiving, at a computing device, transaction information from a buyer and sending, from the computing device, the transaction information over a communication network to a seller. The method further includes receiving, at least periodically at the computing device, a geographical location of the buyer, and sending, from the computing device, the geographical location of the buyer to the seller when the buyer is within a threshold distance of the seller. The method also includes accumulating information about the buyer and their location at a specific store or business. The method may include data analysis of buyer visiting similar businesses.

### CROSS REFERENCE TO RELATED APPLICATIONS

This U.S. patent application claims priority under 35 U.S.C. §119(e) to U.S. Provisional Application 62/042,863, filed on Aug. 28, 2014, which is hereby incorporated by reference in its entirety.

### TECHNICAL FIELD

This disclosure relates to facilitating transactions between buyers and sellers, for example, via a web-based application on a mobile computing device; data accumulation; and/or targeted marketing.

### BACKGROUND

Mobile devices such as smartphones, tablet PCs, cellular telephones, portable digital assistants and other handheld devices have become widespread and essential in personal and business use. Mobile devices were mainly used for voice communication, but recently they have become a reliable source for performing a range of business and personal tasks. Mobile devices are useful to obtain information by either making a phone call to an information center or accessing the interact and inputting a search query for obtaining the requested information. The information requested may be information relating to a location of a restaurant, hotel, shopping center, or any other information such as customer reviews or hours of operation. Some devices include a global positioning system (GPS) that provides the user with their location on an electronic map being displayed on the GPS. In addition, some devices allow the user to enter a specific address or search for a specific location and the mobile device navigates the user to the specific location.

Some smartphones are light in weight and include a display with either a touch input or a miniature keyboard for allowing the user to quickly type emails, text messages, or search ques. Smartphones have become accessible, widely used, and greatly relied on for various tasks (e.g., calendar, maps, navigation, travel, etc). Moreover, web-based applications may now accommodate tasks capable of being performed on a smartphone. Web-based applications are programs designed to be used entirely within a browser and may allow a user to create documents, edit pictures, listen to music, and shop at a specific store without installing complicated software. Other examples of web-based applications include calendars, phonebooks, maps, navigation, gaming, etc.

### SUMMARY

One aspect of the disclosure provides a method of facilitating transactions between a buyer and a seller, using a service provider. The method includes receiving, at a computing device, transaction information from a buyer and sending, from the computing device, the transaction information over a communication network to a seller. The method further includes receiving, at least periodically at the computing device, a geographical location of the buyer, and sending, from the computing device, the geographical location of the buyer to the seller when the buyer is within a threshold distance of the seller.

Implementations of the disclosure may include one or more of the following features. In some implementations, the method further includes electronically displaying a graphical user interface configured to receive the transaction information from the buyer. The transaction information may include at least one of reservation information, purchase information, or buyer preference information. In some examples, the method includes receiving the geographical location of the buyer from a geolocation identifier associated with the buyer. The method may include sending advertisements over the communication network to the buyer based on the geographical location of the buyer.

In some implementations, the method includes receiving, at the computing device, advertisement information from the seller and sending, from the computing device, the advertisement information over the communication network to the buyer when the buyer is within a threshold distance from the seller. The advertisement information may include one or more of the following information: a name of a business, hours of operation, a menu, products sold, reviews, a phone number, an address, and a website.

The method may include storing, in non-transitory memory associated with the computing device, the received geographical locations of the buyer. In some examples, the method includes receiving captured images from the buyer or the seller. The captured images may be associated with a geographical location of the buyer or the seller. The method may include sending, from the computing device, the stored geographical information to the seller. In some examples, the method includes accumulating buyer location patterns and sending the patterns to the seller. The buyer location patterns may include a number of instances the buyer is in a specific location.

Another aspect of the disclosure provides a method for communication and performing transactions between a buyer, a seller, and a service provider. The method includes receiving, at a computing device, transaction information from a buyer and sending, from the computing device, the transaction information over a communication network to a seller. The method includes receiving, at least periodically at the computing device, a geographical location of the buyer. The method includes sending, from the computing device, an activation instruction for a mobile application over the communication network to the buyer when the buyer is within a threshold distance of the seller. The mobile application includes a set of instructions executable on a computing device. In some examples, the method further includes sending the mobile application over the communication network to the buyer.

The method may include electronically displaying a graphical user interface configured to display a current geographical location of the buyer and a location of the transaction. In some examples, the method includes calculating a distance between the current geographical location of the buyer and the location of the transaction and displaying the calculated distance on the graphical user interface. The method may include navigating the buyer from the current geographical location of the buyer to the location of the transaction. Additionally, while navigating the buyer, the method may display on the graphical user interface a location message displaying information relating to a location as the buyer passes by the location.

In some examples, the method includes electronically displaying a graphical user interface configured to receive the transaction information from the buyer. The transaction information may include at least one of reservation information, purchase information, or buyer preference information. The method may include receiving the geographical location of the buyer from a geolocation identifier associated with the buyer. The geolocation identifier may include a global positioning system (GPS) associated with a mobile device of the buyer. In some examples, the method further includes sending advertisements over the communication network to the buyer based on the geographical location of the buyer.

In some examples, the method includes receiving, at the computing device, advertisement information from the seller and sending, from the computing device, the advertisement information over the communication network to the buyer when the buyer is within a threshold distance from the seller. The advertisement information may include one or more of the following information: name of a business, hours of operation, a menu, products sold, reviews, a phone number, an address, and a website.

In some implementations, the method includes storing the received geographical locations of the buyer in non-transitory memory associated with the computing device. The method may include receiving captured images with a geographical location of the buyer. In some examples, the method includes sending the stored geographical information to the buyer from the computing device.

The method may accumulate buyer location patterns and may send the patterns to the seller. The buyer location patterns may include a number of times the buyer is in a specific location.

In yet another aspect of the disclosure, a communication method includes receiving, at a computing device, transaction information from a buyer. The method also includes sending, from the computing device, the transaction information over a communication network to a seller and receiving, at least periodically at the computing device, a geographical location of the buyer. The method includes sending, from the computing device, an activation instruction for a mobile application over the communication network to the buyer after receiving the transaction information. The mobile application includes a set of instructions executable on a computing device. The method also includes sending, from the computing device, the geographical location of the buyer to the seller when the buyer is within a threshold distance of the seller. The first threshold distance is greater than the second threshold distance.

In some examples, the method includes electronically displaying on a graphical user interface configured to display a current geographical location of the buyer and a location of the transaction. The method may include calculating a distance between the current geographical location of the buyer and the location of the transaction and displaying the calculated distance on the graphical user interface. The method may further include navigating the buyer from the current geographical location of the buyer to the location of the transaction. While navigating the buyer, the method may display on the graphical user interface a location message displaying information relating to a location as the buyer passes by the location. In some examples, the buyer sends the transaction information from the mobile application.

The method may include receiving advertisement information from the seller at the computing device, and sending the advertisement information over the communication network from the computing device to the mobile application, when the buyer is within a threshold distance from the seller. The advertisement information may include one or more of the following information: name of a business, hours of operation, a menu, products sold, reviews, a phone number, an address, and a website.

The method may include accumulating buyer location patterns and sending the patterns to the seller, The buyer location patterns may include a number of times the buyer is in a specific location.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary overview of a communication system.

FIG. 2 is a schematic view of an exemplary overview of a communication system between a service provider and a buyer.

FIG. 3 is a schematic view of an exemplary overview of a communication system from a user's home to a user's destination.

FIG. 4 is a schematic view of an exemplary travel application.

FIG. 5 is a schematic view of an exemplary home screen.

FIG. 6 is a schematic view of an exemplary three dimensional view.

FIG. 7 is schematic view of an exemplary video or camera view.

FIG. 8 is schematic view of an exemplary overview of the communication system of FIG. 1.

FIG. 9 is a schematic view of an exemplary arrangement of operations for a method of facilitating a transaction between a buyer and a seller.

FIG. 10 is a schematic view of an exemplary arrangement of operations for a method of facilitating a transaction between a buyer and a seller.

FIG. 11 is a schematic view of an exemplary arrangement of operations for a method of facilitating a transaction between a buyer and a seller.

Like reference symbols in the various drawings indicate like elements.

### DETAILED DESCRIPTION

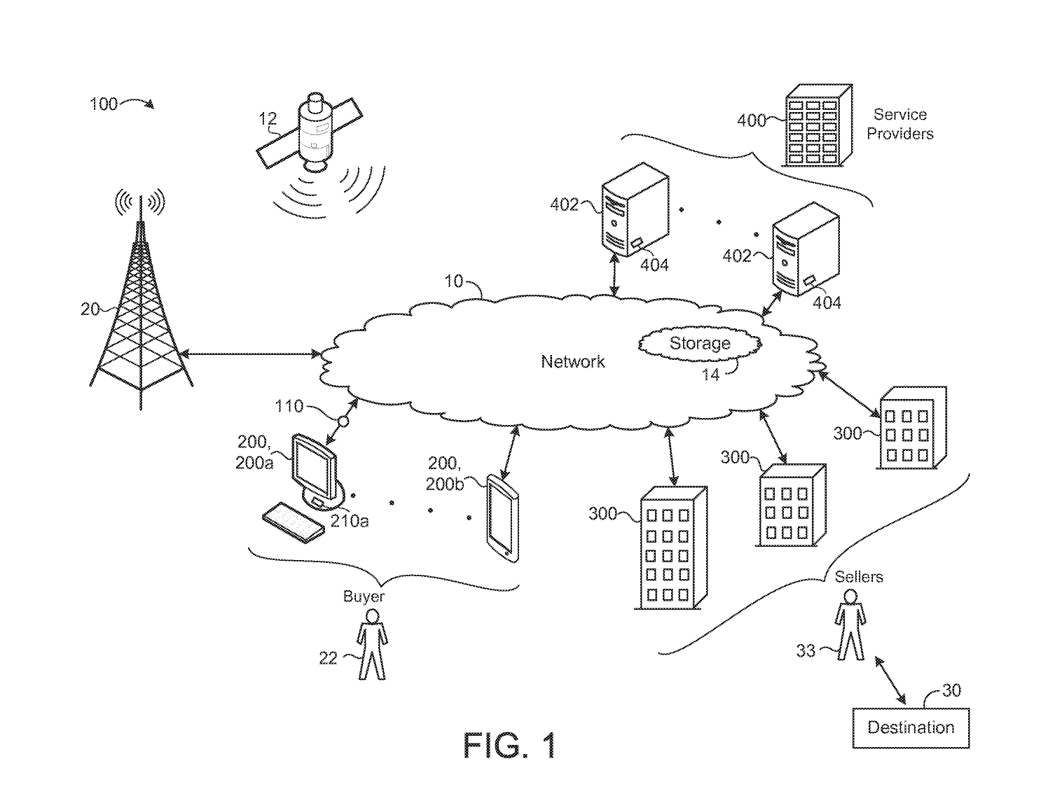

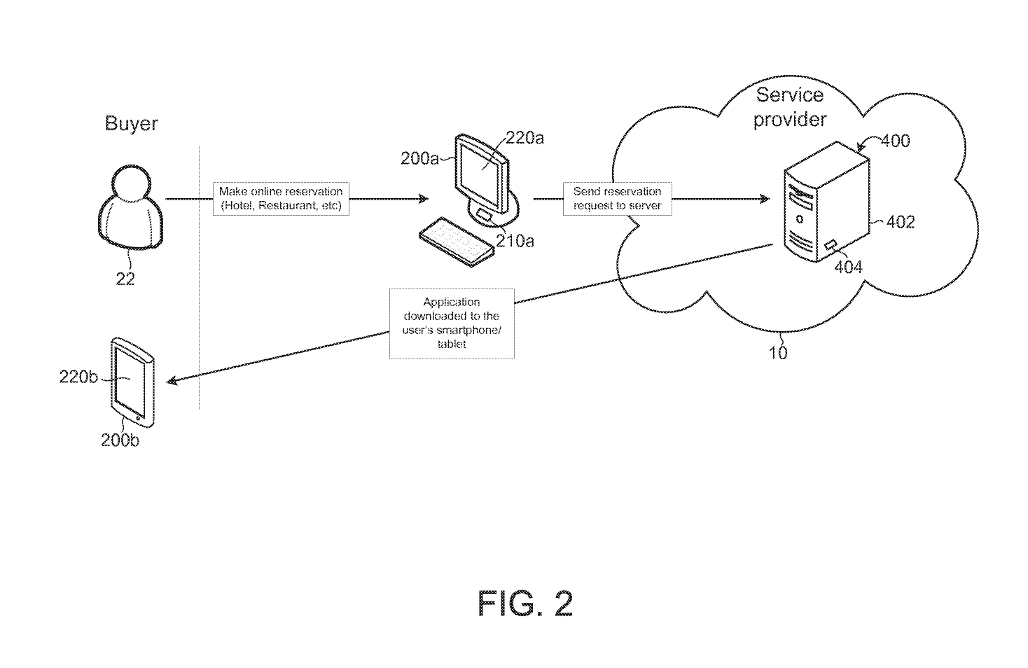

Referring to FIGS. 1 and 2, in some implementations a communication system 100 includes a network 10, a base station 20, and terminals such as user terminals 200, 300 or service provider terminals 400. The terminals 200, 300 may be a wireless device such as cellular phones, smartphones, personal digital assistant, personal computer, a wireless pad, or any other device that is capable of sending and receiving information via the network 10.

The network 10 may include any type of network that allows sending and receiving communication signals such as a wireless telecommunication network, a cellular telephone network, a time division multiple access (TDMA) network, a code division multiple access (CDMA) network, a global system for mobile communications (GSM), a third generation (3G) network, a fourth generation (4G) network, a satellite communications network, and other communication networks. The network may include one or more of a Wide Area Network (WAN), a Local Area Network (LAN), and a Personal Area Network (PAN). In some examples, the network includes a combination of data networks, telecommunication networks, and a combination of data and telecommunication networks. The terminals 200, 300, which include buyer terminals 200 and seller terminals 300, communicate with the network 10 by sending and receiving signals (wired or wireless) via the base station 20. In some examples, the terminal 200, 300 may be in communication with a GPS satellite 12, global navigation satellite system (GNSS) or the like, for determining the position of the terminal 200, 300. In some examples, the network 10 provides cloud computing which is the use of resources such as hardware and software delivered as a service over the network 10. The term ‘cloud’ services generally refers to a service performed not locally on a user's device, but rather delivered from one or more remote devices accessible via one or more networks 10. Since the user's device does not need to know or learn the details of what is happening at the one or more remote devices, the service appears to be delivered from a ‘cloud’ from the perspective of the user's device. End users 22, 33 may access the cloud via a web browser or a web-based application and the data relating to each user is stored on the servers at a remote location. The network 10 may include storage 14 (e.g., non-transitory memory) for storing data.

In some implementations, a buyer 22 executes an online transaction 110 (e.g., using a computer 200a or a mobile computing device 200b) that is associated with a destination 30 through a service provider 400. The transaction 110 may be a purchase or reservation associated with the destination 30. The destination 30 may be any location or an entity associated with that location, such as, but not limited to, a city, a neighborhood, a district, a hotel, a restaurant, a museum, avenue, a building, etc.

In some examples, the service provider 400 allows the buyer 22. to search for a destination 30 or allows the buyer 22 to browse destinations 30 based on price, travel distance from the buyer's home, destination reviews, etc. When the buyer 22 selects a destination 30, the service provider 400 may display on a display 220a (e.g., touch screen or monitor) a view or a series of views that ask the buyer 22 to provide personal information, such as a number of people going to the destination 30, an address of the buyer 22 and addresses of any other people attending, payment information, and/or other information that may be used to execute the transaction 110 (e.g., to make a reservation).

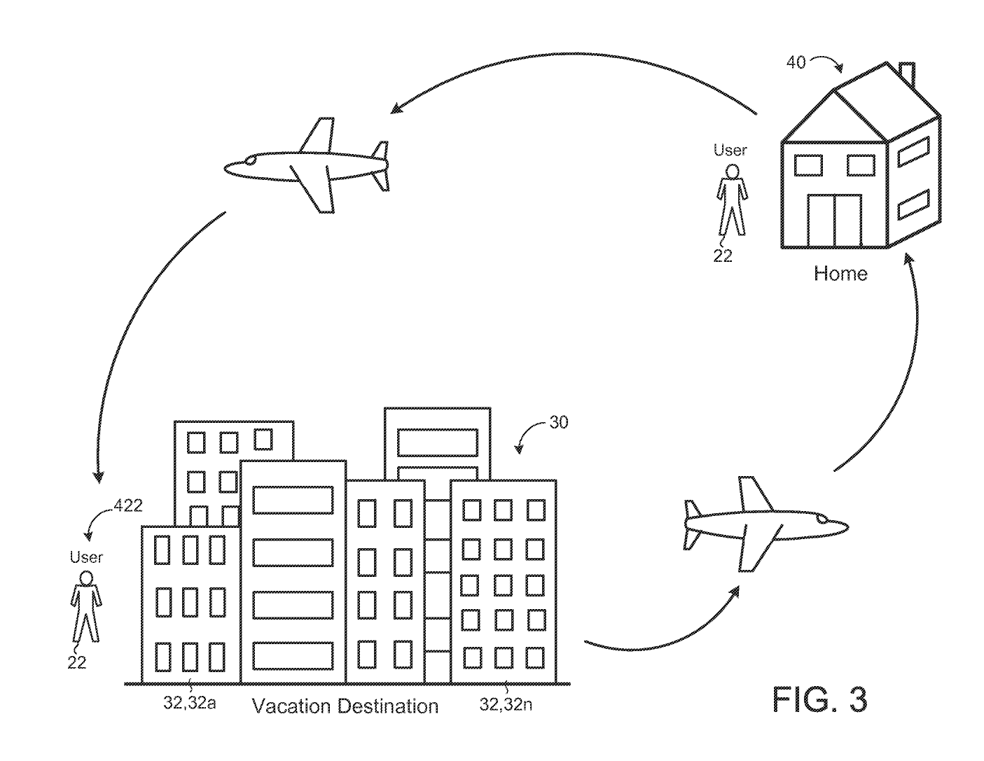

Once the buyer 22 completes the transaction 110, the service provider 400 prompts the buyer 22 to download an application 410 (FIG. 3) on a mobile computing device 200b. If the buyer 22 agrees, the service provider 400 may further ask the buyer 22 for one or more phone numbers or emails associated with mobile computing device(s) 200b to which the buyer 22 wants the application 410 sent. In some implementations, once the buyer 22 completes the transaction 110, the buyer's mobile computing device 200b downloads the application 410. The application 410 may be automatically downloaded to the user's mobile computing device 200b. In some examples, the service provider 400 sends the buyer 22 a link allowing the buyer 22 to download the application 410 at a later time.

There are several ways the application 410 may be installed on the buyer's mobile computing device(s) 200b. In some examples, the application 410 installs when a buyer 22 makes a reservation e.g., makes the payment to book) at a destination location 30, such as at a restaurant or a hotel as previously described. In other examples, a husband and wife may be going on a trip and the wife books the trip including the hotel. In such cases, the wife may enter multiple telephone numbers (e.g., both the wife's phone number and the husband's phone number) and the corresponding mobile computing devices 200b download the application 410. In some examples, a group of people are traveling together and the person who books the trip may input all the travelers phone' numbers and the service provider 400 transmits the application 410 to all of the travelers' mobile computing devices 200b.

Referring to FIG. 3, in some implementations, the buyer 22 makes a reservation at a home location 40 using his/her computer 200a, and the buyer's mobile computing device 200b receives the application 410 while the buyer 22 is at the home location 40. When the buyer 22 agrees to receive the application 410 on the mobile computing device 200b, the application 410 may execute on the mobile computing device 200b in a dormant mode until awoken to an active mode when the buyer 22 is within a threshold distance of the reserved destination 30. Therefore, if the buyer 22 books a trip to a vacation destination, business destination, or local destination 30 a month before the vacation/business/local event date, the application 410 may execute on the buyer's mobile computing device 200b in the dormant mode and then awaken and execute in the active mode when the buyer 22 has arrived at the vacation/business/local destination 30 or is within a threshold distance of the vacation/business/local destination 30. White in the dormant mode, the application 410 may monitor a current geographic location 422 with respect to destination 30 to determine when to switch modes.

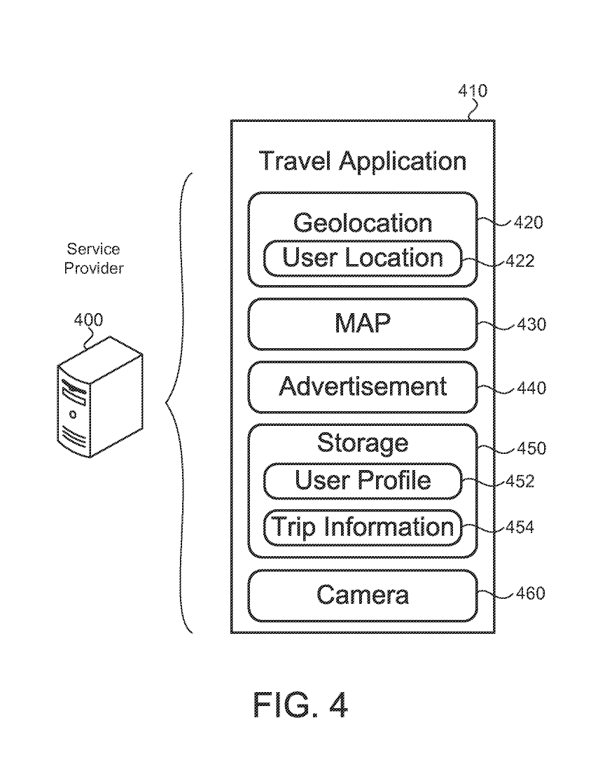

Referring to FIG. 4, in some implementations, the application 410 includes several features, such as geolocation services 420, an interactive map 430, advertisement 440, storage 450 (e.g., for a user profile 452 and trip information 454), and/or a camera 460. The application 410 may include other features not listed.

Geolocation services 420 identify a geographic location 422 of an object (e.g., mobile computing device or computer terminal). Geolocation services 420 use a positioning system to determine a specific location 422, such as a street intersection or an address rather than a set of geographic coordinates. Internet and computer geolocation may be performed by associating a geographic location with the internet protocol address, machine access control (MAC) address, radio frequency identifier (RFID), hardware embedded article or production number, embedded software number, Wi-Fi positioning system, device GPS coordinates, or other information.

In some examples, the geolocation services 420 include a location-based service (LBS), which is an information service for providing specific controls for location and time data. LBS is generally used in social networking and as entertainment services. LBS include services for identifying a location of a person or an object. Some examples include locating a friend, a family member or an employee or locating the nearest restaurant, park, or hotel. In some examples, LBS is used for mobile commerce and for targeting users in a specific location with advertisements and coupons of businesses in the user's vicinity based on the user's location. LBS services may include personalized weather services and news services.

The travel application 410 may include an interactive map 430 allowing the buyer 22 to zoom in and zoom out of the map 430 and display real time traffic at a current location or a specific destination. Other map features may include viewing the map 430 in three dimensions, satellite view, or terrain view (altitude of the location). Additionally, some map features may include adjusting the map 430 to always display the north as the top of the display screen, or to allow the map to move with respect to the position of the user (e.g., buyer 22) and changing the map direction displayed based on the user location. Additionally or alternatively, the map 430 may include features such as adjusting the color settings of the map and the roads.

In some examples, when the buyer 22 makes the reservation, the application 410 creates a user profile 452, which may include the name, age, gender, and address of the buyer 22. The user profile 452 may also include specific information, such as the buyer's favorite restaurant or store, likes or dislikes when at a specific location, or any food allergies. Some or all of the information may be shared with the seller(s) 33 (e.g., at reserved destination 30), making the buyer's experience more enjoyable. For example, if the buyer 22 makes a reservation at a restaurant, the application 410 may inform the restaurant that the buyer 22 is allergic to peanuts, or that the buyer 22 wants to sit by the window.

In some examples, the buyer 22 may book a vacation trip to a destination 30 and include an itinerary having several destination locations 32, 32a-n the buyer 22 wants to visit. The buyer 22 may save the itinerary as trip information 454, allowing the buyer 22 to stay on track and visit all the planned destination locations 32.

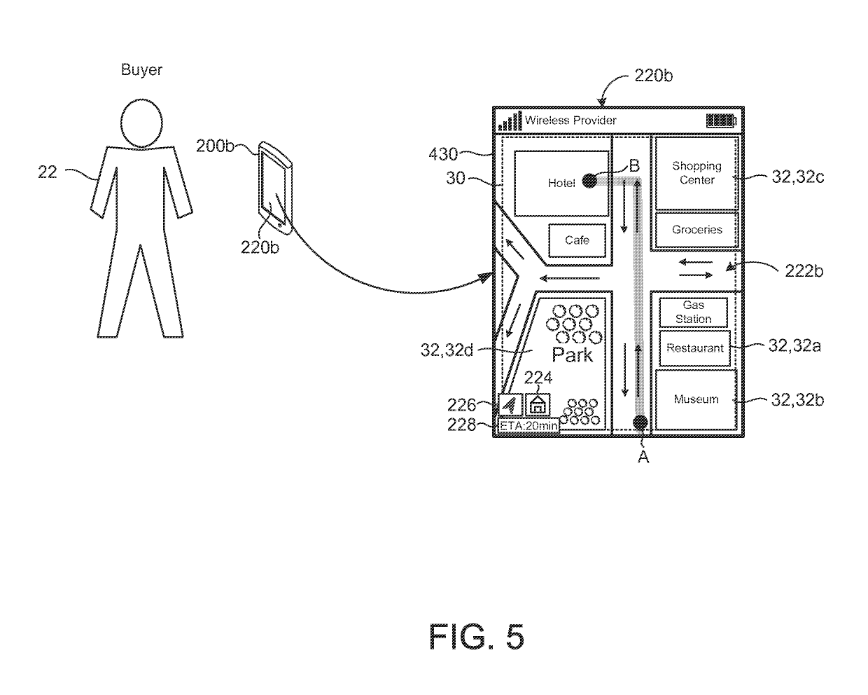

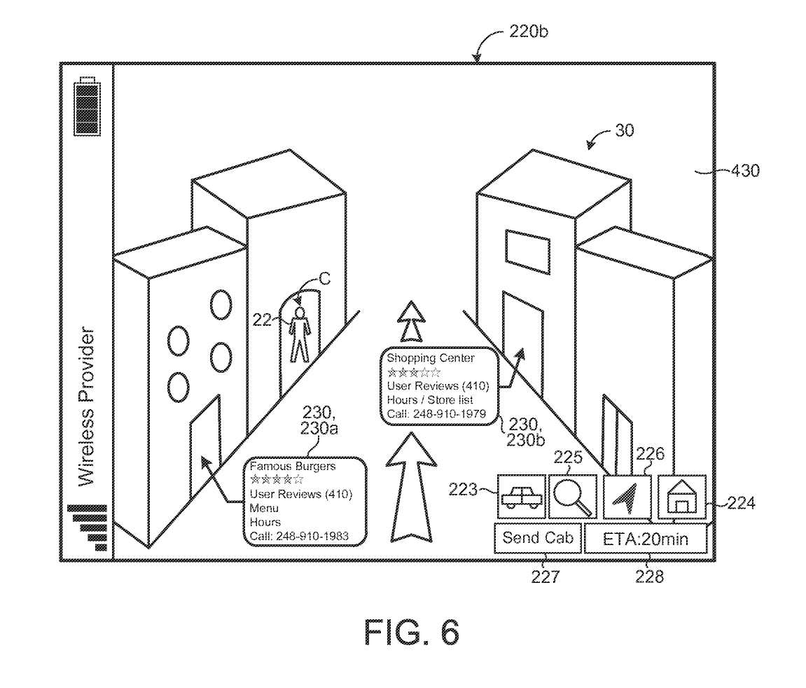

Referring to FIGS. 3 and 5, when the buyer 22 arrives at the booked destination 30, the application 410 launches on the buyer's mobile computing device 200b (i.e., switches execution form the dormant mode to the active mode) and displays a home screen 222b. The home screen 222b displays the buyer's current location A with respect to a reservation location B, allowing the buyer 22 to know the current location A and how to get back to the reservation location B (e.g., a destination location 32, such as a hotel). In some examples, the home screen 222b, or any other map screen, includes a home icon 224 (FIG. 6) linked to the reservation location B. In situations where the buyer 22 is lost or wants a shortcut to return to reservation location B, the buyer 22 may select the home icon 224, which navigates the buyer 22 back to the reservation location B. In some examples, the buyer 22 may be driving, walking, or using the bus to explore the destination 30. The home icon 224 may allow the buyer 22 to choose a mode of transportation (e.g., bus, car, walking, biking) to reach the reservation location B. In some examples, the interactive map 430 also displays locations of interest such as, but not limited to restaurants, pharmacies, gas stations, or hospitals along the route between the buyer's current location A and the reservation destination B.

As the buyer 22 is passing through an area within the destination 30, the application 410 prompts the buyer's mobile computing device 200b to ring or vibrate when the buyer 22 passes destination locations 32, such as a restaurant 32a, a museum 32b, a shopping mall 32c, or a park 32d. In some examples, the buyer 22 may select which destination locations 32 trigger a ring or vibrations, such as restaurants only or shopping malls only. In some implementations, the buyer 22 may filter through a list of nearby businesses for a specific type of business such as French cuisine, Chinese restaurants, jewelry stores, etc.

Referring to FIG. 6, in some implementations, the home screen 222b includes a direction icon 226 showing a heading direction of the buyer 22, e.g., north, north east, east, south east, south, south west, west, or northwest. In some examples, the direction icon 226 automatically adjusts its direction based on the buyer's current location A. The buyer 22 may click on the icon 226 and change the settings of the direction icon 226. The buyer 22 may change the setting so that the direction icon 226 always points to the north and the map 430 adjusts based on the buyer's direction. The buyer 22. may adjust the direction icon 226 so that the direction icon 226 changes with respect to the buyer's current location A. In some implementations, the buyer 22 selects a three dimensional view of the map 430.

In some examples, the home screen 222b, or any other screen that displays the map 430, may include a taxi indicator 227 (e.g., “Send Cab”). When the buyer 22 selects the taxi indicator 227, the hotel is notified of a current location of the buyer 22 and may send a van, a cab, or a shuttle to the current location of the buyer 22. In some examples, the hotel may send a notification to the buyer 22 via the application 410 indicating the time of the arrival of the van, cab, or shuttle. Additionally, the buyer 22 may track the van, cab, or shuttle as it arrives at the location of the buyer 22. In some examples, where the shuttle, van or cab service takes the buyer 22 from the hotel to another location, the application 410 may send the hotel the location information of the buyer 22. This allows the hotel to know where the buyer is at all times and in some instances send specific information to the buyer 22 based on his location. In some examples, the information may include important information relating to the area or the hotel such as the nearest hospital, list of tours available in the city, list of nearby restaurants, list of grocery stores, etc.

The home screen 222b, or any other screen, displaying the map 430 that is navigating the buyer 22 to a destination location 32 (e.g., reservation location B) may include an estimated time of arrival indicator 228 that automatically adjusts as the buyer 22 approaches the destination location 32. In some examples, the estimated time of arrival considers traffic conditions provided by a service provider 400.

In some examples, where more than one buyer 22 is going on a vacation (e.g., husband and wife, a family, a group of friends), a search icon 225 may be displayed on the home screen 222b or any other screen displaying the map 430. When the buyer 22 pushes the search icon 225, the map 430 displays the location C of another buyer 22. This prevents the buyers 22 from losing each other, and allows them to track each other on the vacation. This feature may be activated or disabled by each individual buyer 22.

In some examples, the application 410 may be used by school buses to determine the location of students having a mobile computing device 200 that includes the application. Each school bus may have a mobile computing device 200 having the application. The students may then track the school bus's location and estimate the bus's arrival time at their pick up location addition, substitute bus drivers may find it easier to locate the student pickup route by locating the students in the area. The application may be particularly helpful on school trips where the bus driver or teacher needs to account for every student at all times. Therefore, the application 410 keeps track of the students and their location. In some examples, the application 410 includes a feature that informs the bus driver or teacher if a student was further than a specific distance from the other students.

In some examples, if the buyer 22 activates the display 220b of the mobile computing device 200b while at the destination 30, the display 220b displays an interactive map 430 (e.g., three dimensional map, as shown). When the buyer 22 approaches a first destination location 32a of interest a first pop-up box 230a may appear and then disappear as that first destination location 32a moves off the screen and no longer appears on the map 430. Another pop-up box 230b may appear as the buyer 22 approaches the second destination location 32b. The pop-up boxes 230 may provide information about the corresponding destination locations 32, such as, but not limited to, a name of the location, reviews, hours of operation, a menu (for restaurants), type of products sold, special events, a picture of the front of the location, a phone number, an address, a website associated with the location, etc.

Referring again to FIGS. 1 and 4, the application 410 may provide the buyer 22 with specific advertisements 440 based on the user profile 452 and current location 422. For example, if the buyer 22 indicated a likeness for a certain store and the buyer 22 is within a threshold distance of the store, the application 410 may advertise the store's establishment. In some examples, the service provider 400 provides a subscription for the seller 33 to display its advertisement(s) 440 when the buyer 22 is within a definable distance of the seller 33. The mobile computing device 200b may receive the advertisements 440 (e.g., via a wireless connection) when the buyer 22 reaches the destination 30.

In some examples, the service provider 400 tracks activities of the buyer 22 and determines establishments that the buyer 22 visits, such as restaurants, bars, museums, or hotels. The service provider 400 may then provide the collected information to sellers 300, so that the sellers 300 better understand their customers by learning the type of customers that frequent their establishment and their habits.

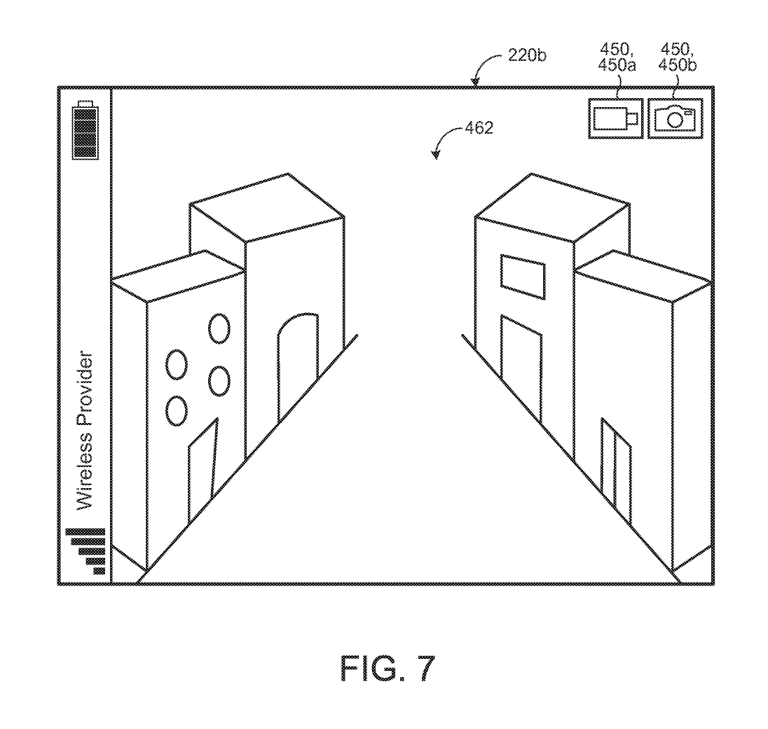

Referring to FIGS. 4 and 7, in some implementations, the application 410 allows the buyer 22 to take a picture or a video 462 and associates the picture or video 462 with a specific location 422 (e.g., a picture of the city). In some examples, the application 410 stores the picture or video 462 in its storage 450 allowing the buyer 22 to retrieve the saved picture or video 462 at a later time.

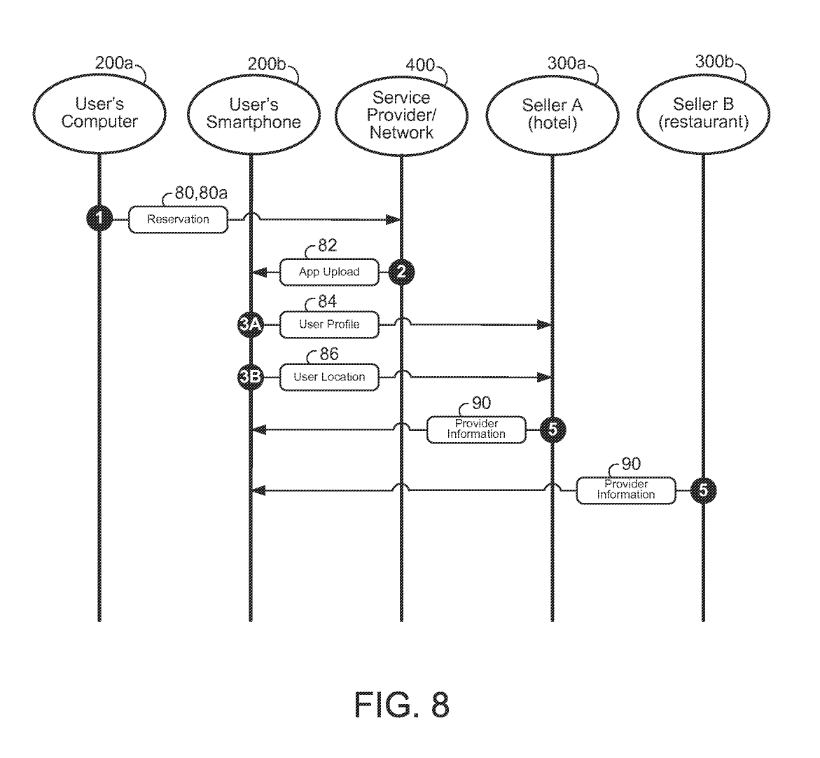

Referring to FIG. 8, in some implementations, a buyer 22 executes a transaction 110 for a hotel reservation 80 in a first city using a computer 200a. The computer 200a sends a message 80a to the service provider 400 confirming the transaction 110. The service provider 400 then sends data 82 to at least one mobile computing device 200b to install the application 410 and execute in the dormant mode. When the buyer 22 is within a predefined distance from the destination 30, in this case, a hotel, the application 410 executes in the active mode and sends a message 84 containing the user profile 452 and/or a message 86 containing the user location 422 to the setter terminal 300a. In some examples, the seller 33 receives an updated location 422 of the buyer 22 periodically (e.g., at 1, 2, 10 min intervals or other time interval).

Referring also to FIG. 5, as an example, if the buyer 22 made a hotel reservation in Miami, Fla. and is coming from Detroit, Mich., the user might make the reservation weeks in advance and have the application executing on his mobile computing device 200b in the dormant mode. When the user arrives in Miami, the application 410 changes modes to the active mode and displays a map 430 of Miami, showing the current location 422, A of the buyer 22 and the destination location B for the reservation. In some examples, the application 410 also displays the distance between the user location A and the destination location B (the hotel) that the buyer 22 reserved. The map 430 may display alternative routes to arrive at the destination location B from the user's current location A. The application 410 may update the hotel staff of the buyer's arrival (once or periodically), allowing the hotel staff to know the exact user arrival time even if the user makes several stops before arriving at the hotel. As the buyer 22 is exploring his vacation destination 30, one or more sellers 33 (or seller terminals 300, 300a, 300b) may send messages 90 including advertisement information 440, such as a business name, location, hours of operation, etc. In some examples, the buyer 22 made a reservation to a restaurant. The application 410 may update the restaurant (e.g., the hostess) of the buyer's arrival time (once or periodically). The application 410 may alert the hostess when the buyer 22 is outside the restaurant and the hostess may communicate with the buyer 22 through the application 410 when his table is ready. In some examples, if the buyer 22 arrives to the restaurant at an earlier time than the reservation was made, the buyer 22 may contact the hostess through the application 410 and ask whether any seating is available. The buyer 22 may use the application 410, to cancel or reschedule the reservation.

In some implementations, the buyer 22 may rent a car on his trip. The rented car may include a bar code that may be saved by the application 410. in such cases, the home screen 222b, or any other screen, displaying the map 430 may include a find my car icon 223 which locates the buyer's rented car on the map 430. A push pin may appear on the map 430. This may be particularly helpful when the buyer 22 forgets what kind of car he is renting or where he parked the rental car. Moreover, the map 430 may indicate a crime level for one or more areas on the map 430 or display an indication of relatively safe areas for travel or one or more areas commonly travelled by tourists.

Referring back to FIG. 4, in some implementations, when the trip is over the buyer 22 may save the trip information 454, including, for example, all the locations visited and any pictures captured, to storage 450. In some examples, the trip information 454 includes the time the buyer 22 spent at a specific location. Therefore, the trip experience can be saved as a file (e.g., on the buyer's computer 200) for future references. In some examples, LBS tracks the buyer's locations and can provide the buyer 22 with a sequential listing of the locations 32 visited. Additionally, the application 410 may display any pictures or video 462 taken that are associated with a specific destination location 32. Therefore, the buyer 22 does not need to remember the location 32 where each picture or video 462 was taken.

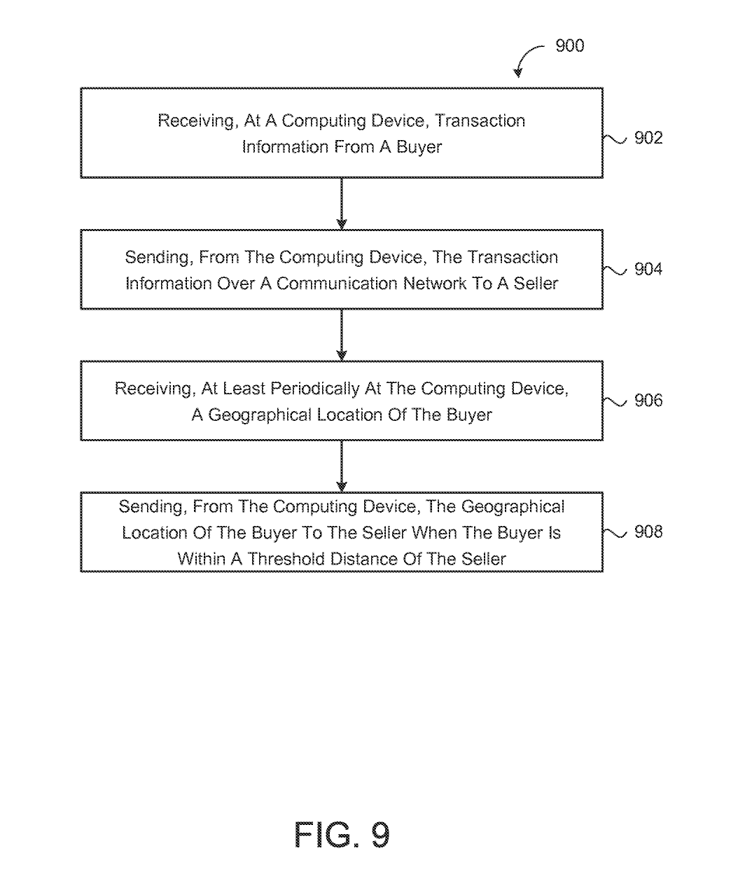

FIG. 9 illustrates an exemplary arrangement of operation for a method 900 of facilitating a transaction 110 between a buyer 22 and a seller 33, using a service provider 400. The method 900 includes receiving 902, at a computing device 402, transaction information 110 from a buyer 22 and sending 904, from the computing device 402, the transaction information 110 over a communication network 10 to a seller 33. The transaction information 110 may include at least one of reservation information, purchase information, or buyer preference information 452. In some examples, a buyer 22 makes a reservation to a hotel in a vacation destination 30 or a reservation to a restaurant that is within few miles from his home location 40. The method 900 further includes receiving 906, at least periodically at the computing device 402, a geographical location 422 of the buyer 22, and sending 908, from the computing device 402, the geographical location 422 of the buyer 22 to the seller 33 when the buyer is within a threshold distance of the setter 33. In some examples, the threshold distance is based on the type of transaction that the buyer 22 has completed. For example, if the buyer 22 booked a hotel at a vacation destination 30, the method 900 may send the location information when the buyer 22 is within a 50 mile radius of the hotel. In some examples, when the buyer 22 makes a reservation to a restaurant, the threshold distance may be significantly smaller than the threshold distance for the restaurant. The discrepancy between the threshold distances to alert the seller 33 of the buyer's location depends greatly on the kind of business the seller 33 is selling. A hotel may require more time to be prepared before their guest (e.g. buyer 22) arrives.

In some examples, the method may include electronically displaying a graphical user interface on a buyer display 220a, 220b configured to receive the transaction information from the buyer 22. In some examples, the method includes receiving the geographical location 422 of the buyer 22 from a geolocation identifier associated with the buyer 22. The geolocation identifier uses geolocation services 420 that the travel application 410 includes. The method 900 may include sending advertisements 440 (e.g., pop-up boxes 230 including restaurant information) over the communication network 10 to the buyer 22 based on the geographical location 422 of the buyer 22.

In some implementations, the method 900 includes receiving, at the computing device 402, advertisement information 440 from the setter 33 and sending, from the computing device 402, the advertisement information 440 over the communication network 10 to the buyer 22 when the buyer 22 is within a threshold distance from the seller 33. The advertisement information 440 presented in a pop-up box 230 may include one or more of the following information: a name of a business, hours of operation, a menu, products sold, reviews, a phone number, an address, and a website (FIG. 6).

In some examples, the method 900 may include storing, in non-transitory memory 404 associated with the computing device 402, the received geographical locations 422 of the buyer 22. In some examples, the method 900 includes receiving captured images 462 from the buyer 22. The captured images 462 include images from a camera or a video. The captured images 462 may be associated with a geographical location 422 of the buyer 22. The method 900 may include sending, from the computing device 402, the stored geographical information 422 to the buyer 22.

In some examples, the method 900 includes accumulating buyer location. patterns and sending the patterns to the seller 33. The buyer location patterns may include a number of instances the buyer 22 is in a specific location. The seller 33 may use the patterns of the buyer 22 to determine the habits of the buyer 22 and what stores or type of stores or locations the buyer 22 often visits. In some examples, the accumulated information includes the number of times a buyer 22 visits a specific store at it various locations, or whether the buyer visits a specific type of store more than others (e.g. furniture stores) which the seller 33 can deduce that the buyer 22 is looking for furniture; therefore, the method 900 includes sending targeted advertisements (e.g. furniture advertisements).

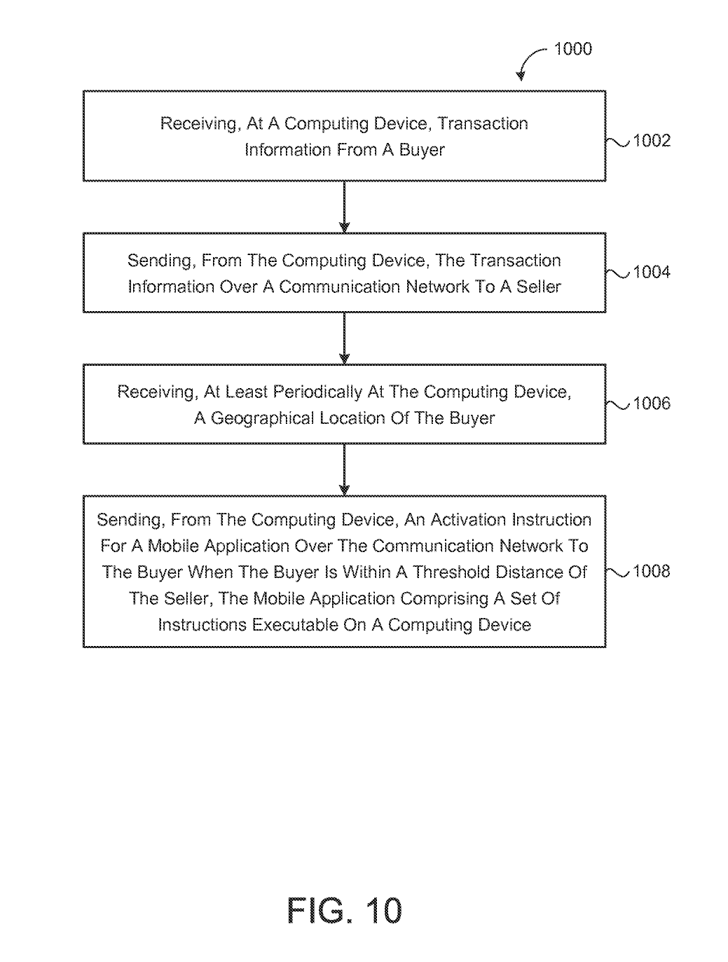

Referring to FIG. 10, in some examples, a method 1000 for communication and performing transactions between a buyer 22, a seller 33, and a service provider 400 is provided. The method 1000 includes receiving 1002, at a computing device 402, transaction information from a buyer 22 and sending 1004, from the computing device 402, the transaction information over a communication network 10 to a seller 33. The method 1000 includes receiving 1006, at least periodically at the computing device 402, a geographical location 422 of the buyer 22. The method 1000 includes sending 1008, from the computing device 402, an activation instruction for a mobile application 410 over the communication network 10 to the buyer 22 when the buyer 22 is within a threshold distance of the seller 33. The mobile application 410 includes a set of instructions executable on a computing device 200a, 200b. In some examples, the method 1000 further includes sending the mobile application 410 over the communication network 10 to the buyer 22.

The method 1000 may include electronically displaying a graphical user interface configured to display a current geographical location 422 (e.g., current location) of the buyer 22 and a location of the transaction (e.g., hotel location). The transaction information may include at least one of reservation information, purchase information, or buyer preference information, In some examples, referring back to FIG. 5, the method 1000 includes calculating a distance between the current geographical location A of the buyer 22 and the location of the transaction 8 and displaying the calculated distance on the graphical user interface (e.g., mobile computing device display 222b). The method 1000 may include navigation the buyer 22 from the current geographical location A of the buyer 22 to the location of the transaction B. Referring back to FIG. 6, while navigating the buyer 22, the method 1000 may display on the graphical user interface 222b a location message (e.g., pop-up box 230) displaying information relating to a location 32 as the buyer 22 passes by the location 32.

In some examples, the method 1000 includes electronically displaying a graphical user interface configured to receive the transaction information 110 from the buyer 22 using a computer or mobile computing device 200. The method 1000 may include receiving the geographical location 422 of the buyer 22 from a geolocation identifier 420 associated with the buyer 22. The geolocation identifier may include a GPS associated with a mobile device 200b of the buyer 22. In some examples, the method 1000 further includes sending advertisements over the communication network 10 to the buyer 22 based on the geographical location 422 of the buyer 22.

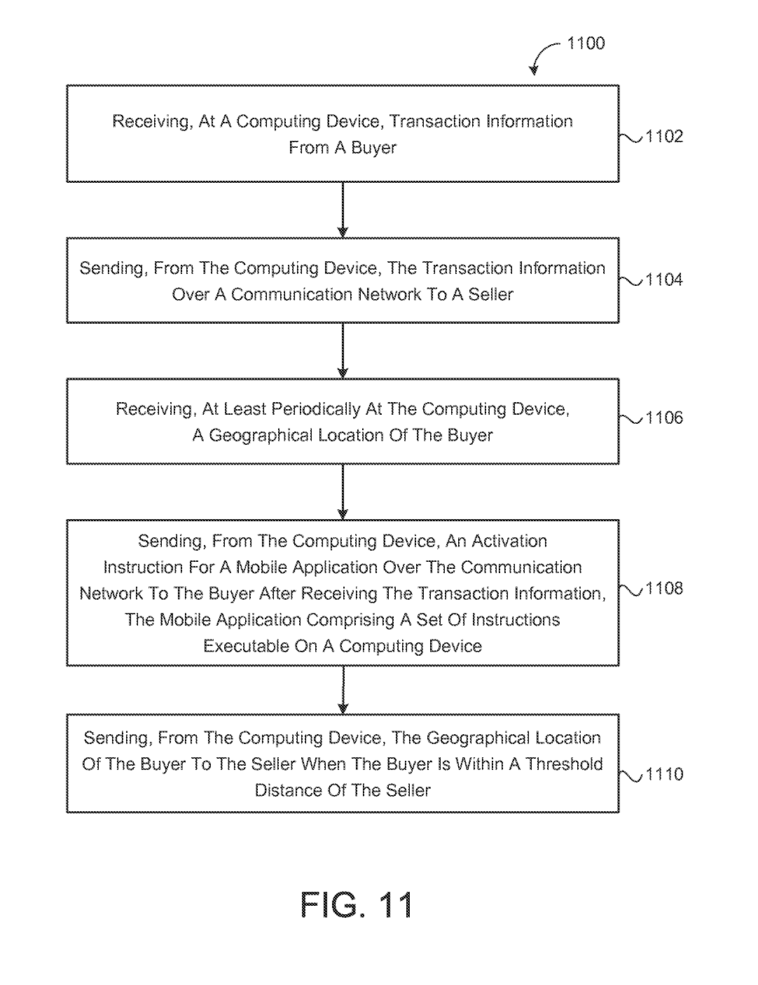

Referring to FIG. 11, in some examples, a method 1100 for communication and performing transactions 110 between a buyer 22, a seller 33, and a service provider 400 is provided. The communication method 1100 includes receiving 1102, at a computing device 402, transaction information 110 from a buyer 22. The method 1100 includes sending 1104, from the computing device 402, the transaction information 110 over a communication network 10 to a seller 33 and receiving 1106, at least periodically at the computing device 402, a geographical location 422 of the buyer 22. The method 1100 includes sending 1108, from the computing device 402, an activation instruction for a mobile application 410 over the communication network 10 to the buyer after receiving the transaction information 110. The mobile application 410 includes a set of instructions executable on a computing device 200. The method 1100 also includes sending 1110, from the computing device 402, the geographical location 422 of the buyer 22 to the seller 33 when the buyer 22 is within a threshold distance of the seller 22.

Various implementations of the systems and techniques described here can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them.

Embodiments of the subject matter described in this specification can be implemented as one or more computer program products, i.e., one or more modules of computer program instructions encoded on a computer readable medium for execution by, or to control the operation of, a data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to a suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA programmable gate array) or an ASIC.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), u mobile audio player, a GPS receiver, to name just a few. Computer readable media suitable for storing computer program instructions and data include forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Implementations of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at a computing device, transaction information from a buyer;
sending, from the computing device, the transaction information over a communication network to a seller;
receiving, at least periodically at the computing device, a geographical location of the buyer; and
sending, from the computing device, the geographical location of the buyer to the seller when the buyer is within a threshold distance of the seller.

2. The method of claim 1, further comprising sending, from the computing device, an activation instruction for a mobile application over the communication network to the buyer after receiving the transaction information, the mobile application comprising a set of instructions executable on a computing device.

3. The method of claim 1, further comprising electronically displaying on a graphical user interface of the computing device a current geographical location of the buyer and a location of the transaction.

4. The method of claim 3, further comprising calculating a distance between the current geographical location of the buyer and the location of the transaction and displaying the calculated distance on the graphical user interface.

5. The method of claim 3, further comprising navigating the buyer from the current geographical location of the buyer to the location of the transaction.

6. The method of claim 5, wherein while navigating the buyer, displaying on the graphical user interface a location message displaying information relating to a location as the buyer passes by the location.

7. The method of claim 1, further comprising electronically displaying a graphical user interface configured to receive the transaction information from the buyer, the transaction information comprising at least one of reservation information, purchase information, or buyer preference information.

8. The method of claim 1, further comprising sending advertisements over the communication network to the buyer based on the geographical location of the buyer.

9. The method of claim 1, further comprising:
receiving, at the computing device, advertisement information from the seller; and
sending, from the computing device, the advertisement information over the communication network to the buyer when the buyer is within a threshold distance from the seller.

10. The method of claim 9, wherein the advertisement information includes one or more of the following information: a name of a business, hours of operation, a menu, products sold, reviews, a phone number, an address, and a website.

11. The method of claim 1, further comprising:
storing, in non-transitory memory associated with the computing device, the received geographical locations of the buyer; and/or
sending, from the computing device, the stored geographical information to the buyer.

12. The method of claim 11, further comprising receiving captured images from the buyer, the captured images associated with a geographical location of the buyer.

13. The method of claim 1, further comprising accumulating buyer location patterns and sending the buyer location patterns to the seller.

14. The method of claim 13, wherein the buyer location patterns include a number of instances the buyer is in a specific location.

15. A method comprising:
receiving, at a computing device, transaction information from a buyer;
sending, from the computing device, the transaction information over a communication network to a seller;
receiving, at least periodically at the computing device, a geographical location of the buyer; and
sending, from the computing device, an activation instruction for a mobile application over the communication network to the buyer when the buyer is within a threshold distance of the seller, the mobile application comprising a set of instructions executable on a computing device.

16. The method of claim 15, further comprising sending the mobile application over the communication network to the buyer.

17. The method of claim 15, further comprising electronically displaying a graphical user interface configured to display a current geographical location of the buyer and a location of the transaction.

18. The method of claim 17, further comprising calculating a distance between the current geographical location of the buyer and the location of the transaction and displaying the calculated distance on the graphical user interface.

19. The method of claim 17, further comprising navigating the buyer from the current geographical location of the buyer to the location of the transaction, wherein while navigating the buyer, displaying on the graphical user interface a location message displaying information relating to a location as the buyer passes by the location.

20. The method of claim 15, further comprising electronically displaying a graphical user interface configured to receive the transaction information from the buyer, wherein the transaction information comprises at least one of reservation information, purchase information, or buyer preference information.

21. The method of claim 15, further comprising sending advertisements over the communication network to the buyer based on the geographical location of the buyer.

22. The method of claim 15, further comprising:
receiving, at the computing device, advertisement information from the seller; and
sending, from the computing device, the advertisement information over the communication network to the buyer when the buyer is within a threshold distance from the seller.

23. The method of claim 22, wherein the advertisement information includes one or more of the following information: name of a business, hours of operation, a menu, products sold, reviews, a phone number, an address, and a website.

24. The method of claim 15, further comprising:
storing, in non-transitory memory associated with the computing device, the received geographical locations of the buyer; and/or
sending, from the computing device, the stored geographical information to the buyer.

25. The method of claim 15, further comprising receiving captured images from the buyer, the captured images associated with a geographical location of the buyer.

26. The method of claim 15, further comprising accumulating buyer location patterns and sending the patterns to the seller.

27. The method of claim 26, wherein the buyer location patterns include a number of times the buyer is in a specific location.
